(19) United States
(12) Patent Application Publication
(10) Pub. No.: US 2007/0101145 A1
(43) Pub. Date: May 3, 2007

(54) Framework for obtaining cryptographically signed consent

(75) Inventors: Kapil Sachdeva, Austin, TX (US); Ksheerabdhi Krishna, Austin, TX (US)

Correspondence Address: ANDERSON & JANSSON L.L.P., 9501 N. CAPITAL OF TX HWY #202, AUSTIN, TX, 78759, US

(73) Assignee: Axalto Inc., Austin, TX (US)

(21) Appl. No.: 11/263,324

(22) Filed: Oct. 31, 2005

(51) Int. Cl. H04L 9/00

(52) U.S. Cl. 713/176

(57) ABSTRACT

A consent service on a host computer providing cryptographically signed consent for user attributes by a user on a host computer to a web service provider. The consent service is operable to provide decryption of the user attributes acquired by the web service provider from an identity provider. The consent service displaying and acquiring user consent to one or more user attributes displayed in a browser web page to the user on the host computer. The consent service is operable to provide encryption of the user consented attributes and to generate cryptographically signed consent of the user. The consent service conveying and transmitting the user consented attribute and cryptographically signed user consent to the web service provider. The web service provider is operable to provide decryption of the user consented attributes and storing the user consented attributes and signed user consent. The web service provider sharing user consented attributes and user signed consent with other web service providers so the user on the host computer can access resources on the other web service providers without multiple authentication or any further interaction with the identity provider.

### TECHNICAL FIELD

The present invention relates generally to user consent in a federation model and more particularly to the framework for obtaining cryptographically signed consent from a user on a host computer.

### BACKGROUND OF THE INVENTION

User authentication is one of the most vexing issues in use and deployment of online services that require reliable knowledge of user identities. Any person who has used services from multiple web based service providers, e.g., online vendors, online banking, or online information providers, knows the difficulty in remembering the myriad of usemames and passwords that one can be required to use in online daily life.

One attempt to solve this issue and streamline the use of online services are Federated Identity Services. Federated identity-based services allow companies to connect their applications with applications of their partners or customers by granting trusted entities access to services and information based on successfully authenticating once with a shared identity management system. Federated identities offer businesses, governments, employees and consumers a more convenient and secure way to control identity information in the digital economy of today, and is a key component in driving the use of e-commerce, personalized data services. The identity management system described herein above is referred to as Identity provider (IDP).

The traditional approach to solving the problem of providing user authentication by allowing a user to authenticate once to an Identity provider for a group of services has been Single Sign On (SSO). In one form of SSO, centralization of access control information into one server requires a special plug-in installed into each Web server to retrieve the information. Every application needs to be “SSO enabled” by programming to the proprietary Application Program Interface (API), which is different for each competing vendor of SSO services. The coding task usually falls to the appropriate Information Technology (IT) organization. Overall, this technology has not been as successful as originally hoped, with many SSO implementations either failing to meet deployment schedules or experiencing scalability challenges. To address these needs, Liberty Alliance provides a framework based on a web services application model. (The Liberty Alliance, a consortium representing organizations from around the world, was created in 2001 to address the technical, business, and policy challenges around identity and identity-based Web services. www.projectlibert.org) Furthermore, Liberty Alliance provides a loosely coupled mechanism of exchanging messages between two incompatible systems by using XML or SOAP for identity providers to interact with web service providers.

In Liberty Alliance, the identity provider facilitates user authentication to a partner service provider and furthermore the identity provider stores user attributes. These user attributes may be needed to give user access to a resource or a service hosted by the service provider. An example of these user attributes is the home address of the user, which may be used by the service provider to send information to the user in response to user's request to access a resource. Furthermore, the identity provider may send the user attributes to the service provider without receiving consent of the user to share these user attributes with the service provider. The service providers generally request for more user attributes then required prior to granting access to a resource or a service. From the foregoing it is evident that user consent is needed before an identity provider shares user attributes with the service provider. Liberty Alliance, which provides a web services based framework for identity and service providers, addresses this need of a consent by providing a solution whereby a user consent is requested prior to sending the user attributes by the identity provider to the service provider. One example of acquiring such a consent from the user is displaying user attributes in a web page of a web browser and providing a check box for each attribute displayed for user to select that attribute and a submit button for user to give consent to share the selected attributes.

The Liberty Alliance solution uses the following methodology:
1. User enters the web address of a service provider in a web browser to access a resource.
2. The service provider requires specific attributes of the user prior to granting user access to the resource. The service provider knows an identity provider that can provide the information regarding user specific attribute.
3. Upon receipt of the request from the user to access a resource, the service provider redirects the user request from the web browser to the identity provider and furthermore in response the identity provider returns user attribute information which is displayed to the user in a web page of the web browser with a checkbox for each attribute displayed and a submit button for the user consent.
4. The user selects one or more attributes by selecting appropriate check boxes and selects the submit button to grant consent to the identity provider. Furthermore, the identity provider upon receiving the user consent to the attributes transmits these user consented attributes to the service provider.

While the Liberty Alliance solution provides a mechanism for obtaining the user's consent to share attributes with the service provider, there is still a risk that an impostor has provided that consent either by having obtained some way of authenticating as the user or by the introduction of malware along the network path between the user and the identity provider. Thus, neither the service provider nor the identity provider can be certain that the consent indeed came from the user.

From the foregoing it will be apparent to those skilled in the art that there is a need for an improved framework that provides an identity provider to share user attributes with a web service provider and furthermore, enabling the user on the host computer to provide consent to share the user attributes using cryptographically signed user consent in a manner that conveys to the web service provider and the identity provider a high level of confidence that it is the user that consented to the attributes being shared.

### SUMMARY OF THE INVENTION

In a preferred embodiment, the present invention provides a framework for an identity provider to share user attributes with a web service provider wherein the user on the host computer consents to the user attributes to share with the web service provider using a cryptographically signed user consent.

In one embodiment for obtaining a cryptographically signed consent, the user requests access to a resource hosted by the web service provider. The web service provider, requiring additional user attributes before granting access to the user, makes a request to the identity provider for those attributes. The identity provider generates a random key (RK) and encrypts the user attributes using the random key RK. Furthermore, the identity provider encrypts the random key RK by using the public key (UPBK) of the user on the host computer to generate an encrypted random key (ERK). An encrypted XML message is produced by the identity provider by embedding the encrypted user attributes and encrypted random key ERK. The encrypted XML message is signed using XML signature thereby providing integrity to the encrypted message. In response to the request for user attributes from the web service provider, the identity provider sends the encrypted XML message to the web service provider.

In one embodiment, the web service provider sends the encrypted XML message received from the identity provider to the host computer and requests the user to cryptographically sign the attributes. A consent service on the host computer decrypts the encrypted XML message received from the web service provider by using a private key of the user (UPRK) on the host computer. The decrypted user attributes are displayed to the user in an interface, such as a web page in a browser or a windows user interface, on the host computer by the consent service. Furthermore, the attributes whose use have been consented to by the user in the interface, referred to herein above and displayed on the host computer by the consent service, are then encrypted by using the public key (WPBK) of the web service provider. The cryptographically signed consent of the user is generated using XML signature. An encrypted XML message is produced by the consent service by embedding the encrypted user consented attributes and the XML signature. In a response to the request to cryptographically sign user consent for the user attributes from the web service provider, the consent service sends the encrypted XML message to the host computer and furthermore, the host computer sends the encrypted XML message to the web service provider.

In one embodiment, the web service provider decrypts the encrypted XML message received from the host computer by using the private key (WPRK) of the web service provider to access user consented attributes and cryptographically signed user consent. The user consented attributes and cryptographically signed user consent are stored in the storage device of the web service provider and grants access to the user on the host computer to a requested resource of the web service provider. Furthermore, the web service provider shares user consented attributes with other web services providers, allowing access to the user on the host computer to federated services hosted by those web service providers.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a schematic illustration of the class of solutions to provide user consent to a web service provider.

FIG. 2 is a schematic illustration of the class of solutions to provide cryptographically signed user consent to a web service provider wherein the consent service is hosted on the host computer.

FIG. 3 is a timing sequence diagram illustrating the data flow in one embodiment of the invention and corresponding to the architecture of FIG. 2.

FIG. 4 is a schematic illustration of an architecture and data flow to provide cryptographically signed user consent to a web service provider wherein the consent service on the host computer is operable of communicating with the identity provider according to one embodiment of the invention.

FIG. 5 is a timing sequence diagram illustrating the data flow in one embodiment of the invention and corresponding to the architecture of FIG. 4.

FIG. 6 is a schematic illustration of an architecture and data flow to provide cryptographically signed user consent to a web service provider wherein the consent service is hosted on a security device such as a smart card and the smart card is a slave device of the host computer according to another embodiment of the invention.

FIG. 7 is a schematic of hardware architecture of a smart card illustrated in FIG. 6.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

I. Introduction

As shown in the drawings for purposes of illustration, the invention is embodied in a novel framework for an identity provider to share user attributes with a web service provider. The signed consent of the user on the host computer to share the user attributes with the web service provider conveys to the web service provider and the identity provider a high level of confidence that it is indeed the user who consented to the attributes being shared. A system according to the invention provides a method in which an identity provider encrypts user attributes to be transmitted via a web service provider to a host computer to obtain consent of the user attributes by the user on the host computer. The user attributes received from the web service provider are decrypted on the host computer and the decrypted attributes are displayed to the user in a user interface on the host computer such as a web page in a web browser or a windows user interface. The attributes consented-to by the user are encrypted and transmitted to the web service provider with cryptographically signed user consent. The web service provider shares these consented-to attributes of the user with other web service providers for the user on the host computer to access services provided by other web service providers.

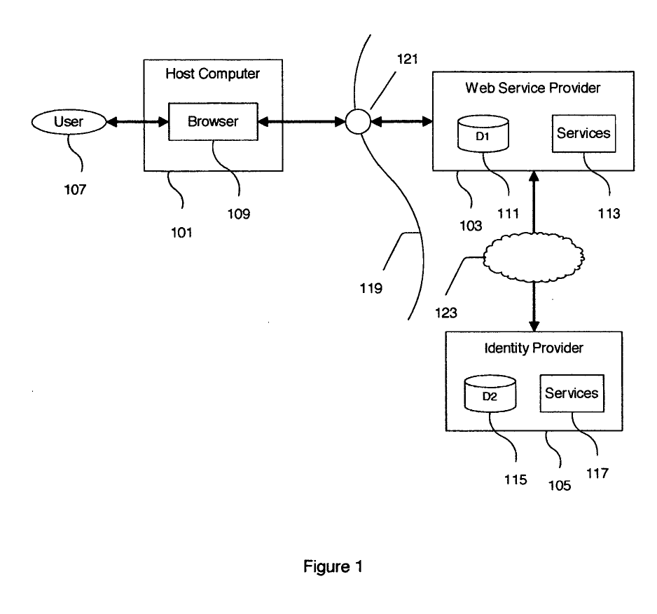

FIG. 1 is a schematic illustration of an example of a conventional network connection between a client application such as a web browser 109 on a host computer 101 with a web service provider 103. The host computer 101 communicates to the web service provider 103 via Network Address Translator 121 embedded in the network firewall 119. The web browser 109 on the host computer sends a request from the user 107 to access a resource on the web service provider 103 in which the web service provider 103 makes a request for user attributes from an identity provider 105 holding user attributes on network 123. The identity provider 105 acting as a proxy for a web service provider 103 transmits a page, for example, a browser web page containing the user attributes to a web browser 109 on the host computer 101 for display to the user 107. The user 107 may then grant permission to share the user attributes with the web service provider 103. A problem with the conventional approach is that the consumer of such an identity provider 105, i.e., the web service provider 103, must have great trust in the identity provider 105 as the web service provider 103 has no means of ascertaining that the response from the user 107 indeed is based upon input from the identity provider 105. Record keeping by all parties will support resolution of any possible dispute about a breach of such trust. The user 107 has a risk that an identity provider 105, or for that matter any web service provider 103, may misrepresent the user 107. The identity provider 105 should make efforts to induce trust in the user 107, for example by offering transaction logs and deploying sufficiently strong authentication methods.

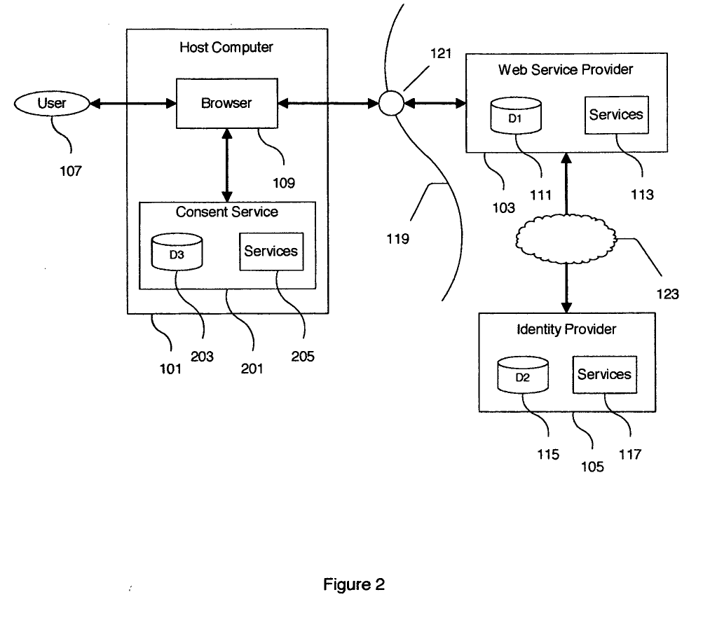

FIG. 2 is a schematic illustration illustrating an example of a high-level view in which a host computer 101 provides a consent service 201 according to the invention. In one embodiment of the invention the software service 205 of consent service 201 communicates to a client application a browser 109 on the host computer 101. The host computer 101 communicates to the web service provider 103 via Network Address Translator 121 embedded in the network firewall 119. In a federation model, the web service provider 103 requires user attributes that can be shared with other web service providers to allow the user 107 to access resources on other web service providers without requiring authentication with each such other web service provider. In this embodiment of the invention, a user 107 requests the web service provider 103 to access a resource in which the web service provider 103 is required to obtain user attributes from an identity provider 105 over network 123. The web service provider 103 redirects the user request to the trusted identity provider 105 for the user attributes. A software service 117 of the identity provider 105 herein referred to as IPservice encrypts the user attributes and sends the encrypted information to the web service provider 103. The web service provider 103, not operable to decrypt this information, sends the encrypted user attributes to the host computer 101 to acquire consent of the user 107. A software service 205 of the consent service 201 herein referred to as CSservice on the host computer 101, decrypts the user attributes and displays the user attributes in a web page of the browser 109. The user 107 consents to the user attributes displayed on the browser 109 and the consented-to user attributes are encrypted by CSservice 205. Communicating with the web browser 109, the CSservice 205 sends the encrypted attributes consented-to by the user with cryptographically signed user consent to the web service provider 103. A software service 113 of the web service provider 103 herein referred to as WSPservice decrypts the user consented attributes and stores the user attributes and the cryptographic user consent in the storage device 111 of the web service provider 103. The web service provider 103, having received the user consented attributes, grants access to the resource requested by the user 107. Furthermore, the web service provider 103 shares the user attributes with other web service providers, thus granting access to those providers' resources without the involvement of the identity provider 105. However, that implementation must only be considered as an example and not as a restriction on the claims.

II. Flowchart

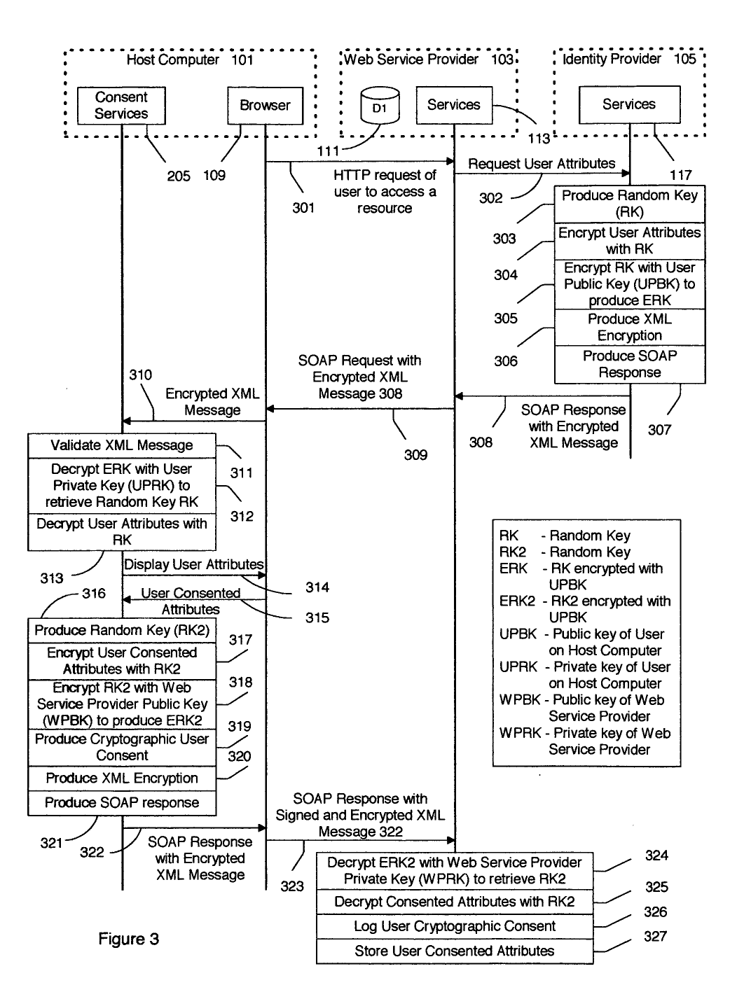

FIG. 3 is a timing sequence diagram illustrating the message flow in one embodiment of the invention and corresponding to the architecture of FIG. 2 in which the consent to share user attributes is cryptographically signed, thus providing the identity provider 105 and web service provider 103 a level of trust that the consent has been granted by the user and not by an interloper. In one embodiment of this invention, the web service provider 103 authenticates the user 107 to communicate with the web service provider 103. The brief description provided immediately herein below is expanded upon in greater detail further below wherein the web service provider 103 requires the user 107 to grant consent to additional user attributes prior to web service provider 103 allowing access to resource on the web service provider 103 or services on other web service providers.
1. The user 107 opens a browser 109 on the host computer 101 and requests access to a resource on the web service provider 103, using HTTP request message 301. In one embodiment, the web service provider 103 requires consent of the user 107 for additional user attributes hosted at the identity provider 105 prior to granting access to the user 107 to the requested resource.
2. The WSPservice 113 having prior knowledge that the identity provider 105 on the network 123 can provide the user specific attribute information, establishes a communications link to the identity provider 105 and requests the user specific attributes, message 302. The web service provider 103 request to the identity provider 105 is represented as a SOAP (Simple Object Access Protocol) request. SOAP is a lightweight protocol for exchange of information in a decentralized, distributed environment. It is an XML based protocol that consists of three parts: an envelope that defines a framework for describing what is in a message and how to process it, a set of encoding rules for expressing instances of application-defined datatypes, and a convention for representing remote procedure calls and responses.

3. In one embodiment, the IPservice 117 generates a random key RK, step 303, e.g., a key conforming to Advanced Encryption Standard (AES). AES, also known as Rijndael, is a block cipher adopted as an encryption standard by National Institute of Standards and Technology (NIST) as US FIPS PUB 197. The IPservice 117 encrypts the user specific attributes using the random key RK, step 304. An example of user attributes stored in the storage device 115 of the identity provider 105 is illustrated below in Table I.

TABLE I
An example of user attributes stored by the identity provider.

```
1 <UserAttrInfo
      xmlns=‘http://exampleuser1.org/attribute
      v2’>
2 <Name>John Smith</Name>
3 <PhoneNumber>800 876 5432</PhoneNumber>
4 <MobilNumber>866 766 1234</MobilNumber>
5 <FaxNumber>866 987 6543</FaxNumber>
6 </UserAttrInfo>
```

4. The IPservice 117 operable of knowing the public key UPBK of the user 107 encrypts the random key RK using the user public key UPBK, generating encrypted random key ERK, step 305. The IPservice 117 generates a message embedding the encrypted user attributes of step 304 and the encrypted random key ERK of step 305 using XML encryption, step 306. The IPservice 117 generates a SOAP response with the encrypted XML message of step 306, step 307. An example of encrypted XML message of step 306 generated by IPservice 117 is illustrated below in Table II.

TABLE II
An example of the identity provider generated XML encryption
message.

```
1 <?xml version=‘1.0’?>
2 <UserAttrInfo
        xmlns=‘http://exampleuser1.org/attribute
        v2’>
3 <EncryptedData
        Type=‘http://www.w3.org/2001/04/xmlenc#Element
        ‘xmlns=’http://www.w3.org/2001/04/
        xmlenc#’>
4 <EncryptionMethod
        Algorithm=‘http://www.w3.org/2001/04/xml enc#aes128-cbc’/>
5 <ds:KeyInfo
        xmlns:ds=‘http://www.w3.org/2000/09/xmld
        sig#’>
6 <ds:RetrievalMethod URI=‘#EK’
        Type=“http://www.w3.org/2001/04/xmlenc#Encrypted Key”>
7 <ds:KeyName>Sally Mae</ds:KeyName>
8 </ds:KeyInfo>
9 <CipherData>
10 <CipherValue>MYUSERATTRIBUTES
        </CipherValue>
11 </CipherData>
12 </EncryptedData>
13 </UserAttrInfo>
```

The AES-128-CBC in item 4 herein is a symmetric key cipher. The random key RK in item 6 of Table II herein is located at a memory location address ‘#EK’. The ds:KeyName in item 7 of Table II herein provides an alternative method of identifying the key needed to decrypt the CipherData. Either or both the ds:KeyName in item 7 of Table II herein and ds:KeyRetrievalMethod in item 6 of Table II herein could be used to identify the same random key RK.
5. The IPservice 117 in a response to the SOAP request, message 302 from the WSPservice 113, sends a SOAP response generated in step 307 to the web service provider 103, message 308. The message 308 received by the web service provider from the identity provider 105 is encrypted using the public key UPBK of the user 107 and furthermore cannot be decrypted by the WSPservice 113. The WSPservice 113 redirects the message 308 received from the identity provider 105 to the browser 109 on the host computer 101, message 309.
6. The browser 109 on the host computer 101 sends the SOAP request containing the encrypted XML message from the web service provider 103 to the CSservice 205, message 310. The CSservice 205 validates the XML signed message received from the web service provider 103, step 311. Furthermore, the CSservice 205, which has the private key UPRK of the user 107, decrypts the encrypted random key ERK to retrieve the random key RK, step 312. The CSservice 205 decrypts the user attributes using the random key RK, step 313. The decrypted user attributes are displayed in a web page of the browser 109 by the CSService 205 to obtain the consent of the user 107, message 314. In one embodiment, the web page displayed to the user 107 comprises each user attribute with a selection checkbox and a submit button to obtain user's consent to use selected attributes. The user 107 selects one or more user attributes displayed in the web page of the browser 109 and activates the submit button in the web page of the browser 109. The browser 109 then conveys the selected user attributes to the CSservice 205, message 315.
7. The CSservice 205 having received the user consented attributes from the browser 109 on the host computer, generates a random key RK2, step 317, e.g., a key conforming to Advanced Encryption Standard (AES). The CSService 205 encrypts the user consented attributes using the random key RK2, step 318. The CSservice 205 operable of knowing the public key WPBK of the web service provider 103 encrypts the random key RK2 using the web service provider public key WPBK, generating encrypted random key ERK2, step 318. Furthermore, in one embodiment, the CSservice 205 generates cryptographically signed consent of the user on the host computer using XML Signature, step 319. (The XML Signature is a method of associating a key with referenced data; it does not normally specify how keys are associated with persons or institutions, nor the meaning of the data being referenced and signed. XML Signatures provide integrity, message authentication, and signer authentication services for data of any type, whether located within the XML that includes the signature or elsewhere.) The CSservice 205 generates a message embedding the encrypted user consented attributes of step 317, the encrypted random key ERK2 of step 318 and the XML signature of step 319 using XML encryption, step 320. The CSservice 205 generates a SOAP response with the encrypted XML message of step 320, step 321. The CSservice 205, in a response to the SOAP request message 310 from the web service provider 103, sends the SOAP response generated in step 321 to the browser 109 on the host computer, message 322. Furthermore, the browser 109 on the host computer 101 sends the SOAP response containing encrypted XML message from the CSservice 205 to the web service provider 103, message 323.
8. The web service provider 103 having received the SOAP response containing encrypted XML message 323 from the browser 109 on the host computer 101, sends the message 323 to WSPservice 113. The WSPservice 113 having the private key WPRK of the web service provider 103 decrypts the encrypted random key ERK2 to retrieve the random key RK2, step 324. The WSPservice 113 decrypts the user consented attributes using the random key RK2, step 325. Furthermore, the web service provider 103 logs the cryptographically signed consent of the user 107 in the storage device 111 of the web service provider 103, step 326 and stores the user consented attributes in the storage device 111 of the web service provider 103, step 327.

The framework of this invention to obtain the cryptographically signed consent of user 107 on host computer 101, as described in the above message flow, is constituted by CSservice 205 and the web service provider 103 communicating to the identity provider 105 on the network 123. Furthermore, the web service provider 103 using the user consented attributes provides to the user 107 access to the requested resource or access to the resources on other web service providers in a federation model without any further involvement of the identity provider 105.

III. Alternate Embodiment

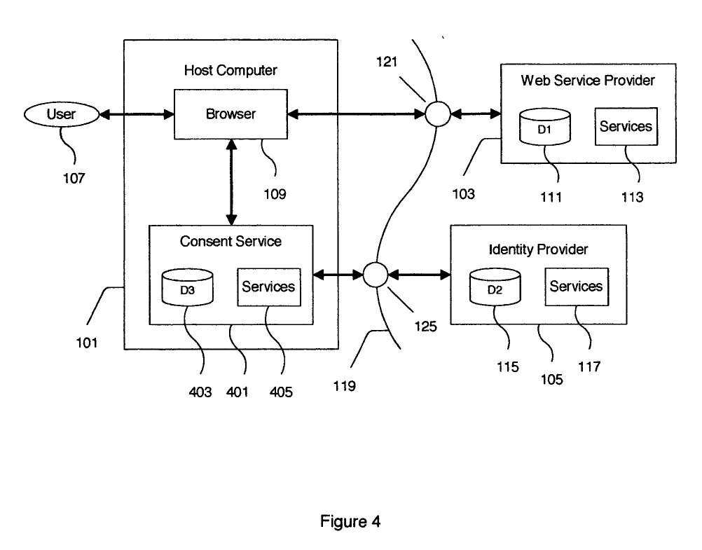

As described herein-above, illustrated in FIG. 4 is an alternate embodiment of the invention in which a host computer 101 provides a consent service 401 wherein the consent service is operable to communicate to the identity provider 105 via Network Address Translator 125 embedded in the network firewall 119. In one embodiment of the invention the software service 405 of consent service 401 communicates to a client application, e.g., a browser 109 on the host computer 101. The host computer 101 communicates to the web service provider 103 via Network Address Translator 121 embedded in the network firewall 119. In a federation model, the web service provider 103 requires user attributes that can be shared with other web service providers to allow the user 107 to access resources on other web service providers without requiring authentication with each such other provider. In this embodiment of the invention, a user 107 requests the web service provider 103 to access a resource for which the web service provider 103 is required to obtain user attributes from an identity provider 105. The web service provider 103, which is not operable to communicate directly to the identity provider 105, sends a request to the browser 109 for user 107 to consent to user attributes. The web service provider request for user consent to user attributes is displayed in a web page of the browser 109. The user's consent to permit the web service to provide the requested user attributes is sent to the CSservice 405. Next, the CSservice 105 transmits the request to the identity provider 105 by communicating via Network Address Translator 125 embedded in the network firewall 119. The IPservice 117 encrypts the user attributes and sends the encrypted information to the CSservice 405. The CSservice 405 decrypts the user attributes. The user attributes are re-encrypted by the CSservice 405 with a request for user's cryptographic signature. The CSservice 405 communicating with the web browser 109 sends the encrypted user attributes with a cryptographically signed user consent to the web service provider 103. The WSPservice 113 decrypts the user consented attributes and stores the user attributes and the cryptographically signed user consent in the storage device 111 of the web service provider 103. The web service provider 103, having received the user attributes, grants user 107 access to the resource requested. Furthermore, in one embodiment, the web service provider 103 may share the user attributes with other web service providers to which the user 107 may have access, thereby permitting the user to access these resources without the involvement of the identity provider 105. However, that implementation must only be considered as an example and not as a restriction on the claims.

III.A. Flowchart

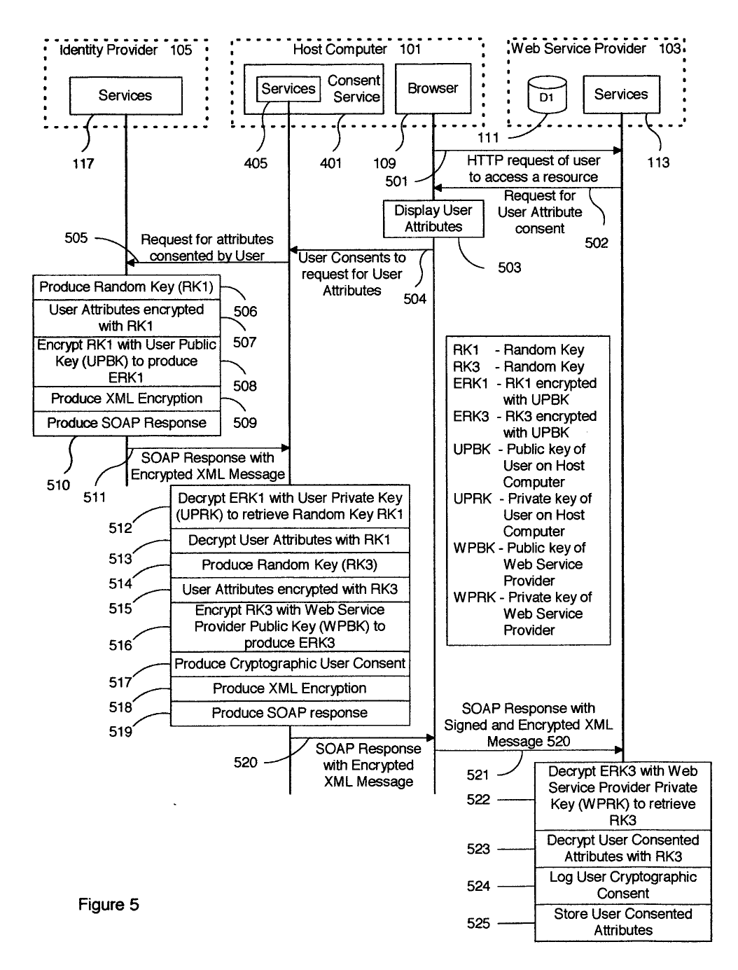

FIG. 5 is a timing sequence diagram illustrating the message flow in one embodiment of the invention and corresponding to the architecture of FIG. 4. In one embodiment of this invention, the web service provider 103 authenticates the user 107 to communicate with the web service provider 103. As described in greater detail immediately below, the web service provider 103 requires the user 107 to grant consent to additional user attributes prior to web service provider 103 allowing access to a resource on the web service provider 103 or services on other web service providers.
1. The user 107 opens a browser 109 on the host computer 101 and requests access to a resource on the web service provider 103, message 501. Message 501 is an HTTP request. In one embodiment, the web service provider 103 requires consent of the user 107 for additional user attributes hosted at the identity provider 105 prior to granting access to the user 107 to the requested resource.
2. The WSPservice 113, having prior knowledge that the identity provider 105 can provide the user specific attribute information and because the web service provider cannot communicate to the identity provider 105, WSPservice 113 sends a request to the browser 109 for user consent to specific user attributes, message 502.

3. The user attributes requested by the web service provider 103 in message 502 are displayed in a web page of the browser 109 for obtaining the consent of the user 107, step 503. The browser 109, after recording consent of the user to the user attributes requested by the web service provider 103, sends the now user-approved web service provider 103 request for the specific user attributes to the CSservice 405, message 504. The CSService 405 operable of communicating with the identity provider 105 via Network Address Translator 125 embedded in the network firewall 119 (as shown in FIG. 4), sends the request of web service provider 103 for user attributes to identity provider 105 with the user consent to request for user attributes by the web service provider 103, message 505.
4. In one embodiment, the IPservice 117 generates a random key RK1, step 506, e.g., a key conforming to Advanced Encryption Standard (AES). The IPservice 117 encrypts the user specific attributes using the random key RK1, step 507. An example of user attributes stored in the storage device 115 of the identity provider 105 is illustrated herein above in Table I.
5. The IPservice 117 operable of knowing the public key UPBK of the user 107 encrypts the random key RK1 using the user public key UPBK, generating encrypted random key ERK1, step 508. The IPservice 117 generates a message embedding the encrypted user attributes of step 507 and the encrypted random key ERK1 of step 508 using XML encryption, step 509. The IPservice 117 generates a SOAP response with the encrypted XML message of step 509, step 510. An example of encrypted XML message of step 509 generated by IPservice 117 is illustrated herein above in Table II.
6. The IPservice 117 in a response to the SOAP request message 505 from the CSservice 405 sends a SOAP response generated in step 510 to the CSService 405, message 511. The CSservice 405 wherein having the private key UPRK of the user 107 decrypts the encrypted random key ERK1 to retrieve the random key RK1, step 512. The CSservice 405 decrypts the user attributes using the random key RK1, step 513.
7. The CSservice 405 having decrypted the user consented attributes received from the identity provider 105, generates a random key RK3, step 514, e.g., a key conforming to Advanced Encryption Standard (AES). The CSservice 405 encrypts the user consented attributes using the random key RK3, step 515. An example of user attributes stored in the storage device 115 of the identity provider 105 is illustrated herein above in Table I. The CSservice 405 operable of knowing the public key WPBK of the web service provider 103 encrypts the random key RK3 using the web service provider public key WPBK, generating encrypted random key ERK3, step 516. Furthermore, in one embodiment, the CSservice 405 generates cryptographically signed consent of the user on the host computer using XML Signature, step 517. The CSservice 405 generates a message embedding the encrypted user consented attributes of step 515, the encrypted random key ERK3 of step 516 and the XML signature of step 517 using XML encryption, step 518. The CSservice 405 generates a SOAP response with the encrypted XML message of step 518, step 519. The CSservice 405 in a response to the SOAP request, message 502 from the web service provider 103, sends the SOAP response generated in step 519 to the browser 109 on the host computer, message 520. Furthermore, the browser 109 on the host computer 101 sends the SOAP response containing encrypted XML message 520 from the CSservice 405 to the web service provider 103, message 521.
8. The web service provider 103 having received the SOAP response containing encrypted XML message 521 from the browser 109 on the host computer 101, sends the message 521 to WSPservice 113. The WSPservice 113 having the private key WPRK of the web service provider 103 decrypts the encrypted random key ERK3 to retrieve the random key RK3, step 522. The WSPservice 113 decrypts the user consented attributes using the random key RK3, step 523. Furthermore, the web service provider 103 logs the cryptographically signed consent of the user 107 in the storage device 111 of the web service provider 103, step 524 and stores the user consented attributes in the storage device 111 of the web service provider 103, step 525.

The above-described message flow describes the CSservice 405 hosted on the host computer 101 communicating to the identity provider 105 on the Network Address Translator 125 embedded in the network firewall 119 and the web service provider 103, which constitutes the framework of this invention to obtain the cryptographically signed consent of the user 107 on the host computer 101. Furthermore, the web service provider 103 using the user consented attributes provides access to requested resource to the user 107 and further to resources on other web service providers in a federation model without any further involvement of the identity provider 105.

IV. Another Alternate Embodiment

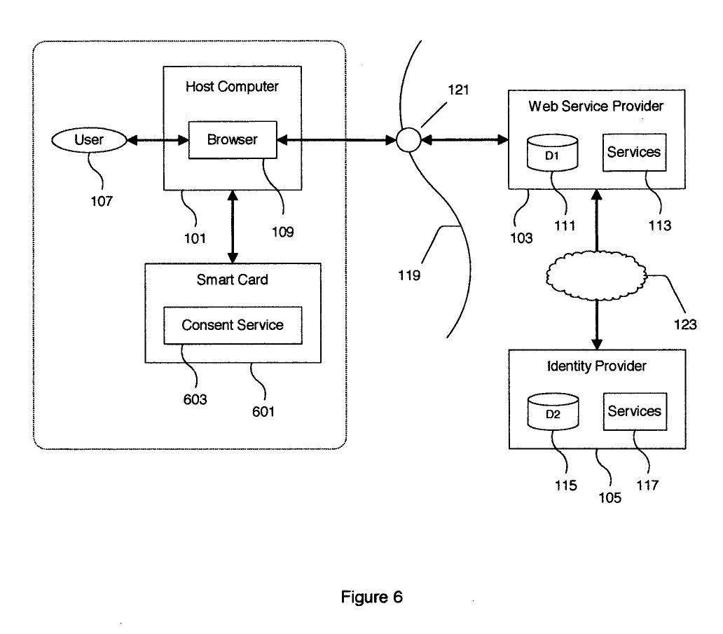

As described herein-above in an another alternate embodiment of the invention, the consent service 603 is hosted on a security device such as a smart card 601 wherein the smart card 601 is a slave device of the host computer 101 as illustrated in FIG. 6. Furthermore, the host computer provides the smart card 601 connectivity and communication to the web service provider 103. The workflow outlined in FIG. 3 applies in its entirety in reference to all the message flow to obtain the cryptographically signed consent of the user 107 on the host computer 101 by the web service provider 103 in conjunction with the identity provider 105.

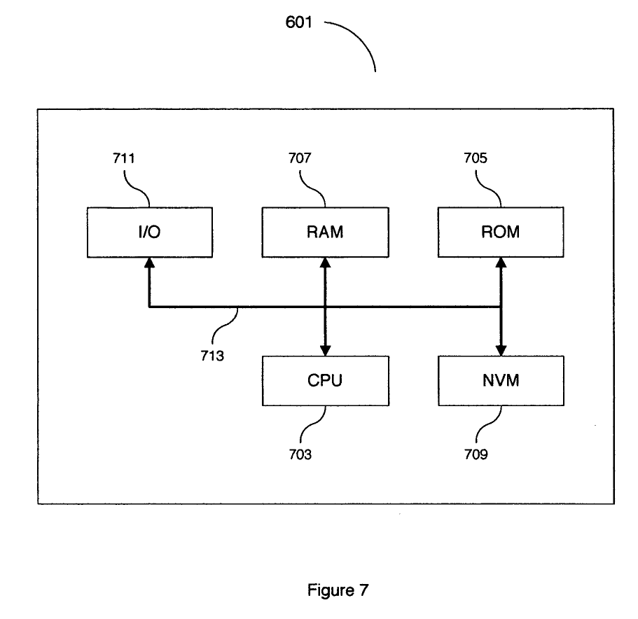

FIG. 7 is a schematic illustration of an exemplary architecture of the hardware of a smart card 601 that may be used in conjunction with the invention. The smart card 601 is a smart card having a central processing unit 703, a read-only memory (ROM) 705, a random access memory (RAM) 707, a non-volatile memory (NVM) 709, and a communications interface 711 for receiving input and placing output to a host computer 101, particularly the electronics of the host computer 101, to which the smart card device 601 is connected. These various components are connected to one another, for example, by bus 713. In one embodiment of the invention, the consent service module 603 illustrated in FIG. 6 would be stored on the resource-constrained device 601 in the NVM 709. The framework for obtaining cryptographically signed consent of a user on a host computer by a web service provider using an identity provider of the present invention as described herein may be implemented as a software program or a collection of software programs having instructions for controlling the CPU 703 of the smart card device 601. These software programs would normally be stored in the NVM 709 and loaded as needed for execution into the RAM 707.

From the foregoing it will be appreciated that the framework for obtaining cryptographically signed consent of a user on a host computer by a web service provider using an identity provider as outlined herein by the present invention represents a significant advance in the art. The present invention provides assurance to the web service provider that no interloper or malicious software that may have been deployed on the host computer could have displayed the web page on the browser to get the consent to user attributes by the user on the host computer. In addition, the web service provider is assured that no interloper or malicious software that may have been deployed on the host computer could have consented to the user attributes on the host computer and have generated the cryptographically signed user consent on the host computer.

Although specific embodiments of the invention have been described and illustrated, the invention is not to be limited to the specific forms or arrangements of parts so described and illustrated. The invention is limited only by the claims.

We claim:

1. A method for obtaining cryptographically signed consent from a user on a host computer, comprising:
requesting access to a resource on a web service provider by a user on a host computer;
in response to request from user to access a resource on the web service provider, generating a request for the user attributes by the web service provider and transmitting the request to an identity provider on the network;
encrypting the user attributes by the identity provider and transmitting the encrypted message to the web service provider;
transmitting encrypted message received from the identity provider by the web service provider to the host computer;
generating user consent by a consent service on the host computer;
transmitting encrypted user consented attributes and cryptographically signed user consent by the host computer to the web service provider; and
decrypting the cryptographically signed user consent and the encrypted user consented attributes by the web service provider and storing the user consented attributes and signed consent of the user in the storage device of the web service provider.

2. The method for obtaining cryptographically signed consent from a user on a host computer of claim 1 wherein the web service provider establishes trust by authenticating the user on the host computer.

3. The method for obtaining cryptographically signed consent from a user on a host computer of claim 1 wherein the web service provider establishes trust with the identity provider on the network and further requests the user attributes from the identity provider.

4. The method for obtaining cryptographically signed consent from a user on a host computer of claim 3 wherein the web service provider request for the user attributes from the identity provider is a SOAP request.

5. The method for obtaining cryptographically signed consent from a user on a host computer of claim 1 wherein the identity provider encrypted message is an encrypted XML message using Advanced Encryption Standard (AES).

6. The method for obtaining cryptographically signed consent from a user on a host computer of claim 5 utilizing the encrypted XML message of the identity provider comprising:
generating an AES random key;
encrypting the user attributes with the AES random key using AES cipher;
encrypting the AES random key with the public key of the user on the host computer; and
generating an encrypted XML message embedding the encrypted user attributes and the encrypted AES random key.

7. The method for obtaining cryptographically signed consent from a user on a host computer of claim 6 wherein the encrypted XML message from identity provider is transmitted to the web service provider in a SOAP response.

8. The method for obtaining cryptographically signed consent from a user on a host computer of claim 1 wherein the method further comprises:
operating the web service provider to:
transmit in a HTTP response, the encrypted XML message received from the identity provider to the host computer; and
request the HTTP response a cryptographically signed user consent.

9. The method for obtaining cryptographically signed consent from a user on a host computer of claim 1 wherein the method further comprises:
operating the consent service on the host computer to:
receive the encrypted XML message in HTTP response from the web service provider;
validate the encrypted XML message received from the web service provider;
decrypt the AES random key using the private key of the user;
decrypt the user attributes using the AES random key;
display the user attributes in a user interface on the host computer to the user and in response recording user consent of the selected attributes;
encrypt user consented attributes with the public key of the web service provider;
generate user consent using XML signature; and
generate encrypted XML message embedding both the XML signature and the encrypted user consented attributes.

10. The method for obtaining cryptographically signed consent from a user on a host computer of claim 9 wherein the user interface on the host computer is a web page in a web browser or a windows user interface.

11. The method for obtaining cryptographically signed consent from a user on a host computer of claim 9 wherein the encrypted XML message from the consent service is transmitted to the host computer and further the host computer transmitting the encrypted XML message to the web service provider in a SOAP response.

12. The method for obtaining cryptographically signed consent from a user on a host computer of claim 1 wherein the method further comprises:
operating the web service provider to:
receive the encrypted XML message in SOAP response from the consent service on the host computer;
decrypt user consented attributes using private key of the web service provider;
extract cryptographically signed user consent from the XML signature;
store the user consented attributes and the signed user consent in the web service provider storage device;
grant the user access to the requested resource; and
share user attributes consented by the user with other web service providers for the user to access resources on other web service providers.

13. A method for obtaining cryptographically signed consent from a user on a host computer, comprising:
requesting access to a resource on a web service provider by a user on a host computer;
in response to the request from user to access a resource on the web service provider, generating a request for user consent to user attributes by the web service provider and transmitting the web service provider request to the host computer;
displaying the user attributes requested by the web service provider in a user interface on the host computer for user consent;
transmitting user consent of request for user attributes by web service provider to a consent service on the host computer;
transmitting user consented request for user attributes by the consent service on the host computer to an identity provider;
encrypting the user attributes by the identity provider and transmitting the encrypted message to the consent service on the host computer;
decrypting the user attributes by the consent service on the host computer from the identity provider's encrypted message;
encrypting user consented attributes and generating cryptographically signed user consent by the consent service on the host computer;
transmitting encrypted user consented attributes and cryptographically signed user consent by the host computer to the web service provider; and
decrypting the cryptographically signed user consent and the encrypted user consented attributes by the web service provider and storing the user consented attributes and signed consent of the user in the storage device of the web service provider.

14. The method for obtaining cryptographically signed consent from a user on a host computer of claim 13 wherein the web service provider establishes trust by authenticating the user on the host computer and further requests consent to user attributes by the user on the host computer.

15. The method for obtaining cryptographically signed consent from a user on a host computer of claim 13 wherein the user interface on the host computer is a web page in a web browser or a windows user interface.

16. The method for obtaining cryptographically signed consent from a user on a host computer of claim 13 wherein the identity provider encrypted message is an encrypted XML message using Advanced Encryption Standard (AES).

17. The method for obtaining cryptographically signed consent from a user on a host computer of claim 16 utilizing the encrypted XML message of the identity provider, the method comprising:
generating an AES random key;
encrypting the user attributes with the AES random key using AES cipher;
encrypting the AES random key with the public key of the user on the host computer; and
generating an encrypted XML message embedding both the encrypted user attributes and the encrypted AES random key.

18. The method for obtaining cryptographically signed consent from a user on a host computer of claim 16 wherein the encrypted XML message from identity provider is transmitted to the consent service on the host computer in a SOAP response.

19. The method for obtaining cryptographically signed consent from a user on a host computer of claim 13 utilizing the consent service on the host computer, the method comprising:
receiving the encrypted XML message from the identity provider;
decrypting the AES random key using the private key of the user;
decrypting the user attributes using the AES random key;
encrypting user consented attributes with the public key of the web service provider;
generating user consent using XML signature; and
generating an encrypted XML message embedding both the XML signature and the encrypted user consented attributes.

20. The method for obtaining cryptographically signed consent from a user on a host computer of claim 19 wherein the encrypted XML message from the consent service is transmitted to the host computer and further transmitted by the host computer to the web service provider in a SOAP response.

21. The method for obtaining cryptographically signed consent from a user on a host computer of claim 1 wherein the consent service is hosted on a security device and the security device is a slave device of the host computer and method further comprising:
operating the consent service on the security device to:
receive the encrypted XML message in HTTP response from the web service provider;
validate the encrypted XML message received from the web service provider;
decrypt the AES random key using the private key of the user;
decrypt the user attributes using the AES random key;
display the user attributes in a user interface on the host computer to the user and in response record user consent to the attributes;
encrypt user consented attributes with the public key of the web service provider;
generate user consent using XML signature; and
generate an encrypted XML message embedding both the XML signature and the encrypted user consented attributes.

22. The method for obtaining cryptographically signed consent from a user on a host computer of claim 21 wherein the security device is a smart card.

23. The method for obtaining cryptographically signed consent from a user on a host computer of claim 21 wherein the user interface on the host computer is a web page in a web browser or a windows user interface.

24. The method for obtaining cryptographically signed consent from a user on a host computer of claim 21 wherein the encrypted XML message from the consent service on the security card is transmitted to the host computer and further the host computer transmits the encrypted XML message to the web service provider in a SOAP response.
